(19) United States
(12) Patent Application Publication
(10) Pub. No.: US 2019/0011700 A1
(43) Pub. Date: Jan. 10, 2019

(54) CUSTOMIZABLE THREE-DIMENSIONAL INTERACTIVE VISUALIZATION AND MULTI-SENSORY SYSTEM AND METHOD

(71) Applicant: Bruce REINER, Berlin, MD (US)

(72) Inventor: Bruce REINER, Berlin, MD (US)

(21) Appl. No.: 16/026,676

(22) Filed: Jul. 3, 2018

Related U.S. Application Data
(60) Provisional application No. 62/528,710, filed on Jul. 5, 2017.

(51) Int. Cl. G02B 27/01; G06F 3/00; G03H 1/02; G03H 1/04

(52) U.S. Cl. CPC G02B 27/0103; G06F 3/002; G03H 2001/0061; G03H 1/04; G02B 2027/0105; G03H 1/024

(57) ABSTRACT

The present invention relates to one or multiple customizable interactive three-dimensional (3D) visualization and multi-sensory technologies useful in a variety of applications, including medical applications and e-commerce. In addition to visualization (which is a common sensory output for all technologies used in the present invention), a number of additional sensory data can be derived including (but not limited to) taste, hearing, smell, vibration, and motion. From this multi-sensory data, in combination with 3D imagery, a myriad of applications can be derived for interactive analysis, including the creation, modification, testing, comparison, query, analysis, and refinement of imaging data, on an individual or collective basis.

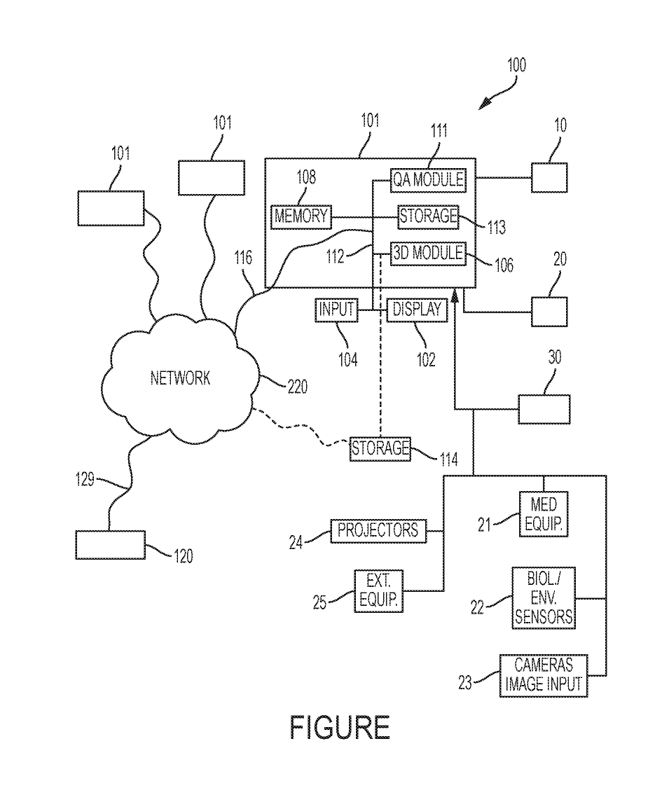

### CROSS-REFERENCE TO RELATED APPLICATIONS

The present invention claims the benefit of U.S. Provisional Patent Application No. 62/528,710, filed Jul. 5, 2017, the contents of which are herein incorporated by reference in their entirety.

### BACKGROUND OF THE INVENTION

### 1. Field of the Invention

The present invention relates to one or multiple customizable interactive three-dimensional (3D) visualization and multi-sensory technologies useful in a variety of applications, including medical applications and e-commerce. In addition to visualization (which is a common sensory output for all technologies used in the present invention), a number of additional sensory data can be derived including (but not limited to) taste, hearing, smell, vibration, and motion. From this multi-sensory data, in combination with 3D imagery, a myriad of applications can be derived for interactive analysis, including the creation, modification, testing, comparison, query, analysis, and refinement of imaging data, on an individual or collective basis.

### 2. Description of the Related Art

Advanced three-dimensional (3D) visualization techniques are currently available for a variety of applications, the vast majority of which are focused on gaming technologies. While the primary sensory input is visual in nature, other sensory input (e.g., haptic, vibratory) is supported to a lesser degree.

However, the use of 3D techniques to produce 3D visualization of a variety of subject matter including (but not limited to) humans and objects, is not yet commonplace. Thus, leveraging these technologies into medical applications or commercial applications, such as e-commerce, would be a technological step forward.

### SUMMARY OF THE INVENTION

The present invention relates to one or multiple customizable interactive three-dimensional (3D) visualization and multi-sensory technologies useful in a variety of applications, including medical applications and e-commerce. In addition to visualization (which is a common sensory output for all technologies used in the present invention), a number of additional sensory data can be derived including (but not limited to) taste, hearing, smell, vibration, and motion. From this multi-sensory data, in combination with 3D imagery, a myriad of applications can be derived for interactive analysis, including the creation, modification, testing, comparison, query, analysis, and refinement of imaging data, on an individual or collective basis.

The present invention has leveraged computerized technologies to provide multisensory functionality visual, auditory, olfactory, tasting, and tactile (i.e., haptic) sensory analysis in combination with 3D imagery. The application and integration of these technologies and accompanying multisensory data can ultimately be used to create a comprehensive user-specific platform which can be used to simulate the real-life experience an individual end-user would have with the local environment and various objects contained within it.

Since sensory perception is to some extent specific to an individual end-user, an integral component of multisensory data analysis is the compilation of both subjective and objective data specific to the individual end-user (i.e., multisensory user-specific profile). This derived user-specific sensory data can in turn be used to record an individual end-user's perceptions, observations, and predications; which are collectively used to create a user-specific multisensory profile. In simplistic terms this defines how an individual end-user perceives context-specific visual, auditory, taste, tactile, and olfactory data.

The combined multisensory data from multiple users and environmental interactions can also be used to create a comprehensive multisensory database, which can be used to predict an individual end-user's perceptions when encountering a new environmental or product interaction. These user-specific predictive analytics can be based upon the collective data of an individual end-user's sensory feedback as well as compilation multisensory data of other “similar” end-users (i.e., comparable multisensory user profiles).

By integrating these computerized multisensory technologies with three-dimensional (3D) virtual imagery (i.e., holograms), one can effectively create a virtual human, capable of experiencing a myriad of user and context-specific sensory interactions with the local environment. This has a number of applications related to safety, consumer-based commerce, education, health, engineering, and technology testing/development.

More specifically, in one embodiment, the present invention can create context and user-specific 3D holograms. The holograms can be triggered through end-user authentication process.

Attributes of the present invention in the various embodiments include: end-users can interact with selected holograms using multisensory data; end-users can initiate communication with a service provider for customization features to the selected hologram (e.g., change color, size, shape, composition material, environmental conditions, etc.); end-users can have a customized life size hologram created (i.e., virtual twin or clone); end-users can have selected holographic items superimposed on holographic twin image (e.g., virtual clothes shopping); end-users can provide requested customization features to superimposed holographic images (e.g., reduce sleeve length one inch, change size or style of lapel) and request virtual tailoring commensurate with requested changes.

In one embodiment, a holographic image can integrate sensors to provide additional feedback (e.g., pressure sensors to detect specific areas where fabric is tight fitting or too loose, pressure sensors to detect excessive perspiration in specific regions with temperature change).

In one embodiment, interactive multisensory data is created and recorded in a database. The data recorded is used to create the end-user and context specific profiles.

In one embodiment, customer feedback based on hologram observations can be stored and analyzed for trending analysis among large populations of end-users.

In one embodiment, a quality control feature allows end-user feedback comparing virtual and live multisensory experiential data (e.g., fit in real life tighter than expected based on interactive hologram data).

In one embodiment, comparative data of end-user and context-specific profiles can be used for customized feedback and targeted marketing (e.g., high likelihood of interest or disinterest based upon feedback of similar end-users and similar products).

In one embodiment, interactive multisensory data analysis and feedback can be directly incorporated into product design and manufacturing (e.g., virtual tailoring).

In one embodiment, multisensory end-user and context specific data can be continuously modified in accordance with environmental and temporal changes (e.g., changes in perfume scent specific to an end-user with increased temperature or stress, modification in drug/gas toxicity with changes in wind patterns, heart rate, or body temperature).

In one embodiment, the database can be used to provide automated alerts based upon end-user feedback.

In one embodiment, virtual testing can be performed where variables are adjusted to provide dynamic feedback to end-users in accordance with their individual concerns. An example is environmental change (e.g., increased temperature, rain), to see how fabric repels water or how an individual end-user's body responds upon extreme temperature variations.

In one embodiment, as an end-user's body undergoes substantive change, virtual analysis can be customized. Examples include end-user post-stroke analysis (e.g., extremity weakness), status post medical/surgical treatment (e.g., mastectomy with lymphedema), dramatic weight gain or loss, prosthetic testing following amputation and change in level of activity.

In one embodiment, computerized simulation can be integrated into the invention to provide real-life analysis of catastrophic event (e.g., dirty bomb radiation, airborne biological agent) with cross-referenced analysis of changes in environmental conditions, modifications in agent of interest, and different end-user characteristics/attributes.

In one embodiment, simulation can also be used to analyze 3D virtual modifications between contextual and end-user interactions. Example includes searching for entertainment technology (e.g., television, stereo, home entertainment system) in different room and furniture designs with changing positions of end-user and modifications in end-user attributes (e.g., visual deficit in one eye, hearing loss at certain frequencies).

In one embodiment, creation of 3D user-specific holograms in which minor (and expected) changes in anatomy which occur over a defined period of time are incorporated into the 3D holographic images as customary or expected end-user variability.

In one embodiment, an end-user specific medical datasheet is created to record and analyze temporal changes, which require additional and/or repeat measurements in order to accurately perform the application of interest specific to the individual end-user.

In one embodiment, assignment of the technology to law enforcement and military intelligence applications can be made, in which people (e.g., criminals, terrorist suspects) and objects of interest (e.g., weapons, buildings) can be recreated using 3D holographic imagery for a variety of purposes including (but not limited to) identification, classification, characterization, and training.

In one embodiment, temporal 3D holographic imaging data are created which can show change over time to an individual end-user and/or context specific holographic image (e.g., weight change, interval growth, surgical change in anatomy, product redesign).

In one embodiment, the ability to modify and test the interaction effect is created, between the end-user, context, and environmental changes (e.g., degree and location of perspiration for a shirt when environmental temperature increases by 20 degrees Fahrenheit). In one embodiment, changing environmental conditions can be factored into the analysis.

In one embodiment, the ability to directly compare and correlate “real life” and virtual” data is created for the purpose of iterative technology refinement (e.g., returns of products in which the 3D holographic imagery was misleading or invalid).

In one embodiment, in addition to 3D holographic imagery of “external” anatomy, 3D holographic images can also be created of “internal” anatomy at both macroscopic and microscopic levels using a variety of imaging techniques for data collection including (but not limited to) photography, endoscopy, medical imaging, genomics, and molecular imaging.

In one embodiment, multiple holographic images can be simultaneously utilized for analysis, which may be related to different entities or objects (e.g., holographic image of sweater superimposed upon holographic image of human) or intrinsic to the same entity (e.g., holographic images of superficial and internal anatomy intrinsic to a single person).

In one embodiment, the ability to dynamically modify (or manipulate) 3D holographic images over time (i.e., temporal holographic image transformation) is created, which may be due to expected (e.g., physiologic events) or unexpected change (e.g., post-traumatic events).

In one embodiment, a virtual imagery and multi-sensory system, includes: a plurality of biological sensors and environmental sensors, which receive input from one or more users and an environment of said one or more users, respectively, which input is provided to a three-dimensional (3D) visualization module; a plurality of image-capturing devices which take and forward images to the 3D visualization module which creates 3D virtual imagery of the one or more users; and a projection system which projects the 3D virtual imagery of the one or more users integrated by the 3D visualization module with the input from the plurality of biological sensors and environmental sensors, such that the one or more users experience sensory interactions with the 3D virtual imagery using the plurality of biological and environmental sensors.

In one embodiment, the plurality of image-capturing devices includes at least one of cameras, radiographic devices, ultrasound, or volumetric medical imaging.

In one embodiment, the biological sensors include at least one of visual, auditory, taste, tactile, or olfactory sensors, and the environmental sensors include at least one of pressure, acoustic, temperature, or air quality sensors.

In one embodiment, the virtual imagery and multi-sensory system further includes: a plurality of external systems which are configured to change the environment of the one or more users; wherein the plurality of external systems change the environment based upon changes requested by the one or more users.

In one embodiment, the plurality of external systems includes at least one of an HVAC system or a drug/gas toxicity system.

In one embodiment, the 3D virtual imagery is a hologram.

In one embodiment, the hologram provides one or more users sensory interactions using at least one of the plurality of biological sensors, the plurality of environmental sensors, or the plurality of external systems, feedback from the one or more users from interaction with the hologram is returned to the 3D visualization module, such that the 3D visualization module can continuously modify output to the hologram, and the plurality of biological sensors, the plurality of environmental sensors, and the plurality of external systems, to accommodate for any biological, environmental or temporal changes.

In one embodiment, the one or more users can request customization of said hologram.

In one embodiment, the computerized simulation is integrated into an environment to provide real-life analysis of a catastrophic environmental event.

In one embodiment, the modified output to the hologram shows changes in anatomy which occurred over a defined period of time of the one or more users.

In one embodiment, the 3D visualization module compares and correlate real-life data and virtual data from the hologram, the one or more users, and the environment, to accomplish iterative technology refinement.

In one embodiment, multiple holographic images are simultaneously utilized for analysis by the 3D visualization module, which may be related to different entities or objects or intrinsic to a same entity or object.

In one embodiment, the virtual imagery and multi-sensory system further includes: a quality assurance module which analyzes hologram image quality from the feedback from the one or more users; wherein when the hologram image quality varies from prior data measurements, then quality assurance testing is required to determine any discrepancies.

In one embodiment, virtual testing is performed using the hologram, where variables to the hologram are adjusted to provide dynamic feedback to the one or more users in accordance with their individual concerns.

In one embodiment, the feedback based on the hologram can be analyzed for trending analysis among large populations of end-users.

In one embodiment, the hologram is used in medical applications.

In one embodiment, the medical application includes one of a virtual surgery, or a virtual surgical tool.

Thus, has been outlined, some features consistent with the present invention in order that the detailed description thereof that follows may be better understood, and in order that the present contribution to the art may be better appreciated. There are, of course, additional features consistent with the present invention that will be described below, and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

The description of the drawing is only one exemplary embodiment of the disclosure and not to be considered as limiting in scope.

The sole FIGURE is a schematic diagram which shows the overall components of the apparatus, according to one embodiment consistent with the present invention.

### DETAILED DESCRIPTION OF THE INVENTION

The present invention relates to one or multiple customizable interactive three-dimensional (3D) visualization and multi-sensory technologies useful in a variety of applications, including medical applications and e-commerce. In addition to visualization (which is a common sensory output for all technologies used in the present invention), a number of additional sensory data can be derived including (but not limited to) taste, hearing, smell, vibration, and motion. From this multi-sensory data, in combination with 3D imagery, a myriad of applications can be derived for interactive analysis, including the creation, modification, testing, comparison, query, analysis, and refinement of imaging data, on an individual or collective basis.

In one embodiment, the present invention includes a plurality of primary components, which in turn can be subdivided into a number of subcomponents. In one embodiment, the primary components include 3D imagery (which can include human, inanimate, and environmental components) handled by a 3D visualization module, a quality assurance module that continuously improves the applications of the present invention, a referenceable database (which incorporates standardized data related to individual or institutional end-users, image technology providers, image sources and associated data, and derived analytics), and a myriad of applications which can be applied to the 3D images for interactive analysis. The present invention represents an ever-expanding variety of resources and applications which can be used in the creation, modification, testing, comparison, query, analysis, and refinement of imaging data; a number of non-limiting applications which are discussed below.

According to one embodiment of the present invention as illustrated in the sole FIGURE, applications may be implemented using the system 100. In one embodiment, the system 100 of the present invention includes a client computer 101, such as a personal computer (PC), which may or may not be interfaced or integrated with external components such as other computer systems, medical equipment 21, biological or environmental sensors 22, cameras 23, and a 2-D or 3-D projection system 24.

The client computer 101 may include an imaging display device 102 that is capable of providing high resolution digital images in 2-D or 3-D, for example. According to one embodiment of the invention, the client computer 101 may be a mobile terminal, and may be operated by the user accessing the program remotely.

According to one embodiment of the invention, an input device 104 or other selection device, inputs commands to a user interface. The input device 104 may include a multi-function programmable stylus, keyboard, mouse, speech processing device, laser pointer, touch screen, or other input device 104.

In medical applications, the system 100 is designed to interface with existing information systems such as a Hospital Information System (HIS) 10, a Radiology Information System (RIS) 20, a radiographic or other medical device 21, and/or other information systems that may access a computed radiography (CR) cassette or direct radiography (DR) system, a Picture Archiving and Communication System (PACS) 30, and/or other systems. The system 100 may be designed to conform with the relevant standards, such as the Digital Imaging and Communications in Medicine (DICOM) standard, DICOM Structured Reporting (SR) standard, and/or the Radiological Society of North America's Integrating the Healthcare Enterprise (IHE) initiative, among other standards.

According to one embodiment of the invention, the client computer 101 may include a 3D visualization module 106 that provides client data processing of inputted image and data files, and a quality assurance module 111 that performs analysis of inputted data. According to one embodiment of the invention, each of the 3D visualization module 106 and quality assurance module 111 may include a processor, an input/output (I/O) interface, and a software program, and/or other components. A memory 108 stores data inputted into the system 100. According to one embodiment of the invention, the components all may be connected by a bus 112. Further, the client computer 101 may include the input device 104, the image display device 102, and one or more secondary storage devices 113. According to one embodiment of the invention, the bus 112 may be internal to the client computer 101 and may include an adapter that enables interfacing with a keyboard or other input device 104. Alternatively, the bus 112 may be located external to the client computer 101.

According to another embodiment of the invention, in addition to a projection system 24, high-resolution goggles 24 may be used as a graphical display to provide end users with the ability to review images. According to another embodiment of the invention, the high-resolution goggles may provide graphical display without imposing physical constraints of an external computer.

According to one embodiment of the invention, the 3D visualization module 106 or quality assurance module 111 may execute a program that is configured to perform predetermined operations. While the system of the present invention may be described as performing certain functions, one of ordinary skill in the art will readily understand that the program may perform the function rather than the entity of the system itself. The system 100 may include a plurality of modules that perform sub-operations of an operation, or may be part of a single module of a larger program that provides the operation.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to the server 120 and/or the client computer 101, either directly or indirectly through a communication network, such as a LAN, WAN, and/or other networks. The data storage device 113 may be an internal storage device. According to one embodiment of the invention, the system 100 may include an external storage device 114.

According to one embodiment of the invention, the client computer 101 may be coupled to other client computers 101 or servers 120. According to one embodiment of the invention, the client computer 101 may access other systems via a communication link 116, such as a wired and/or wireless communication link, a switched circuit communication link, or may include a network of data processing devices such as a LAN, WAN, the Internet, or combinations thereof.

According to one embodiment of the invention, the server 120 may include a single unit or may include a distributed system having a plurality of servers 120 or data processing units. The server(s) 120 may be shared by multiple users in direct or indirect connection to each other. The server(s) 120 may be coupled to a communication link 129 that is preferably adapted to communicate with a plurality of client computers 101.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer 101, the server 120, or both.

According to one embodiment of the invention, in a client-server environment, at least one client and at least one server are each coupled to a network 220, and/or the Internet, over a communication link 116, 129. Further, even though any external systems such as the radiographic device 21, cameras 23, etc., are shown as directly coupled to the client computer 101, it is known that these systems may be indirectly coupled to the client over a network or the Internet via communication links.

According to another embodiment of the invention, the client computer 101 may be a basic system and the server 120 may include all of the components that are necessary to support the software platform. Further, the present client-server system may be arranged such that the client computer 101 may operate independently of the server 120, but the server 120 may be optionally connected. In the former situation, additional modules may be connected to the client computer 101. In another embodiment consistent with the present invention, the client computer 101 and server 120 may be disposed in one system, rather being separated into two systems.

Although the above physical architecture has been described as client-side or server-side components, one of ordinary skill in the art will appreciate that the components of the physical architecture may be located in either client or server, or in a distributed environment. Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more servers 120 may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, or other forms of ROM or RAM either currently known or later developed. Further, although specific components of the system have been described, one skilled in the art will appreciate that the system suitable for use with the methods and systems of the present invention may contain additional or different components.

In one embodiment, the present invention is directed to the incorporation of multisensory analysis into 3D holographic (or other forms of advanced visualization) technology which allows for the creation of context and user-specific holographic datasets, which can be customized in accordance with end-user preferences and attributes.

In one embodiment, advanced 3D visualization techniques include (but are not limited to) augmented reality, virtual reality, and holography. While the primary sensory input is visual in nature, other sensory input (e.g., haptic, vibratory) 22, 25 is supported to a lesser degree. Existing supporting technologies include (but are not limited to) headsets, glasses, goggles, gloves, and sensors 22, 25.

In one embodiment, in order to support 3D visualization, a variety of data acquisition technologies 21, 22, 23, 25 can be employed including (but not limited to) lasers, photography, radar (i.e., ultrasound), and volumetric medical imaging (e.g., computed tomography, magnetic resonance imaging). These technologies can be used in isolation or combination to produce 3D visualization of a variety of subject matter including (but not limited to) inanimate objects, humans, animals, flora, and environmental entities. In one embodiment, the acquisition data can undergo advanced data processing by the 3D visualization module 106 to produce multisensory 3D imagery, which can be supplemental to the local environment of the end-user (e.g., augmented reality, holography) or completely replace the end-user environment (e.g., virtual reality).

In one embodiment, a variety of display technologies 102, 24 are used for 3D hologram visualization, beginning with head-mounted displays and evolving into planar imagery using binocular visual aids (e.g., glasses) based on anaglyphs, time-division, and polarization. Further evolution of hologram technology has led to alternative technologies which do not rely on visual aids such as parallax barrier and lenticular lens array.

In one embodiment, advanced 3D visualization uses physical 3D space to render graphics and create visual representations in three physical dimensions. These 3D volumetric displays provide the ability to view holographic images from any angle by arranging voxels in 3D space, by either emitting or reflecting light. The resulting 3D imagery can utilize a variety of applications including (but not limited to) augmented reality, aerial user interfaces, and volumetric (expression) imagery. Volumetric expression is of particular interest because the content scale corresponds to the human body, therefore it can be useful when applied to wearable materials and spatial user interactions. The ability to create volumetric mapping of imaging data effectively creates real-world-oriented user interfaces.

In addition to 3D holograms being presented as visual sensory data, other forms of sensory data can be integrated into hologram technology. Haptics is a form of sensory interaction which creates the impression of tactility (i.e., touch). The haptics technology 25 works through the integration of small devices (i.e., actuators) which provide a mechanical motion to an electrical stimulus (i.e., applies forces to the skin in order to produce the sensation of touch). A relevant use case is in the gaming industry where virtual reality (VR) gloves 22, 25 provide garners with the visceral sensation of touch with various objects on the simulated VR environment. Another application is in the design industry where a designer can interact with “elastic” 3D holographic images to mold, modify, and preview designs through tactile 3D hologram displays.

Another technology used with the present invention is touchable holography, which is an airborne ultrasound tactile display 25 which provides tactile sensation onto the user's hand through the use of nonlinear ultrasound, acoustic radiation pressure. When an object interrupts the propagation of ultrasound, a pressure field is exerted on the object. When the tactile display radiates the ultrasound, a user can feel the tactile sensation on bare hands (i.e., devoid of gloves) in free space with no direct contact.

Another example of a “touchable” hologram utilizes femtosecond lasers which pulse at one quadrillionth of a second and turn air in a single point into plasma (i.e., ionized air) which one can touch. The lasers pulse so rapidly that disruption of the laser displays by human touch (i.e., haptic feedback) can provide real-time instantaneous feedback, analogous to a moving a mouse 104 in a computer screen 102 and receiving real-time visual feedback.

Other technologies used with the present invention are those related to digital transmission of taste and smell sensory data. “Whiffer” is the generic term given to an olfactory delivery device (i.e., electronic nose) 22, 25. This is an input device used to collect and interpret odors or smells in a variety of occupational settings including the military (e.g., warfare detectors), police (e.g., drug detectors), food industry (e.g., quality control), and electronic commerce (e.g., cosmetics, perfumes). Miniaturized technology is currently available to integrate this technology into smartphones (e.g., Scentec), which can emit a variety of fragrances to simulate smell.

In another technology used with the present invention, digital taste simulation technology 22, 25 is currently being developed which uses electrical stimulation of the tongue through embedded silver electrodes. By manipulating the current magnitude, frequency, and temperature one can effectively simulate different components of taste (e.g., salty, sour, bitter).

The above technologies illustrate examples of technical solutions which are used with the present invention to incorporate multisensory data input directly into 3D holography for creating virtual multisensory input, for the purpose of simulating the comprehensive sensory experience unique to the individual end-user, in a variety of applications. The resulting user and context specific data can in turn be used to create both multisensory user-specific profiles and perform multisensory data analyses, the analyses of which can provide customizable predictive analytics.

In one embodiment directed to medical applications, the present invention utilizes cameras 23 to take 3D images of a patient, process those images using the 3D visualization module 106, and provide holographic visualization of the images using a projection system 24, either on the patient or as a 3D visualization of the medical data displayed on the display 102.

In one embodiment, more specifically, the program can customize the data to the individual patient (e.g., body habitus, breast size, age), medical condition (e.g., primary diagnosis, comorbidities, routine medications), treatment provided or planned (e.g., specific type of surgical procedure, radiation therapy, chemotherapy), and even healthcare providers (e.g., surgeon, medical oncologist, radiation therapist). This ability to customize the data for analysis allows the present invention to provide predictive analytics with respect to the patient. Showing these predictive changes in patient specific 3D holographic data is extremely beneficial to patient treatment strategy, patient education, post-treatment patient management, and even provider selection. In one embodiment, the present invention is used by healthcare providers to customize and optimize the treatment strategy in accordance with patient anatomy, pathology, and physiology.

In one embodiment, the predictive analysis of the analysis of the medical data results in the projection of holographic images generated by the 3D visualization module 106. The predictive analysis of the present invention allows a physician to create 3D holographic images of the patient, which can provide the physician detailed information to assess the different treatment options specific to the patient body form. The physician will be presented with 3D imagery of how each different treatment option will appear, and the program can analyze the medical data and apply it to the 3D images, so that the physician can visualize the potential post-treatment complications on the patient, and their potential impact on anatomic change. In other words, the physician can literally compare post-operative outcomes of different surgeons, visualize anticipated changes in post-operative anatomic forms (specific to the individual surgeons and type of surgical procedure to be performed), and analyze the type and severity of potential post-procedural complications. This ability to predict and directly visualize medical treatment planning is used to obtain better informed consent and improve patient decision making.

In one exemplary embodiment, a breast cancer patient's physician can utilize the present invention to analyze the different options available for the patient's treatment. For example, different surgical and/or radiation therapy options are presented by the program to the physician and/or patient (each with different rates of morbidity/mortality for the specific type and stage of breast cancer), and the program allows the user to view 3D holographic images created by the program for the different treatment options specific to the patient body form; thereby providing the physician and/or patient with 3D imagery of how each different treatment option will appear, along with the potential post-treatment complications and their potential impact on the patient's body.

Thus, in the present invention, the surgeon can dynamically modify the patient's 3D holographic image using a number of surgical options and techniques with the goal of finding the best strategy for balancing the often-competing demands of clinical outcome and anatomic distortion.

In the previously cited example of breast cancer diagnosis, the patient may have a locally aggressive form of breast cancer with limited axially lymph node metastasis. While total mastectomy coupled with radiation therapy and chemotherapy may provide the greatest chance for cure, this would be quite disfiguring to the patient's anatomy, which is of great concern to the patient. Accordingly, alternative, less invasive surgical options could be explored and directly visualized using 3D holography and correlated by the 3D visualization module 106 with expected morbidity and mortality specific to the patient's diagnosis. In addition to the “basic” and “well defined” surgical options, the surgeon may have learned of a new technique which has only been performed on a limited number of patients, but with promising results.

In this example, using 3D holographic imagery, the surgeon can visualize comparative anatomic change of the various surgical options while correlating these options specific to the individual patient breast size, tumor type, and requirement for axillary lymph node dissection. This dynamic capability to modify patient and disease-specific anatomy commensurate with different treatment options presents a unique capability for healthcare providers to comparatively assess options for intervention.

In one embodiment, the present invention's technology of 3D visualization can also be applied to creation of surgical simulation tools to assist in provider education and decision making. In the prior example, the breast surgeon learned of a new alternative surgical procedure which is less disfiguring to the breast and has the potential for high cure rates. However, since the surgical procedure is relatively new, he/she has no prior practical experience, which may be a limiting factor. If however, the surgeon can use the 3D holographic imagery to create a surgical simulation tool specific to the patient anatomy and disease, they may be able to practice the new procedure using 3D imagery and gain increased confidence and experience prior to ‘real life” utilization. This would be a vast improvement in the underlying technology of computer simulation tools which do not provide patient-specific anatomic imagery, which is particularly important in the setting of atypical anatomy (e.g., anatomic variation, prior surgery, concomitant pathology).

In one embodiment, the present invention provides the advantage of dynamic data analysis. For example, the 3D visualization module 106 would note changes in end-user anatomy from the inputted data of the patient, which would in turn allow the module 106 to alter the 3D holographic body form image and its interaction with the product of interest.

One example might include a woman who is in the early stages of pregnancy and wishes to determine the effect of pregnancy (i.e., anatomy change) on sweater fit. She can first experience the interaction of the sweater on her personal 3D holographic image at baseline (i.e., prior to pregnancy weight gain) and then incrementally over time experience how the sweater-body interaction changes over the course of predicted weight gain. On the most simplistic level, the predicted weight gain can be generalized in keeping with rough estimates. More complex models can be used which incorporate historical end-user specific data (e.g., based on previous pregnancies), meta-data from “similar” end-users (e.g., based on end-user profiles which utilize height, weight, and body habitus data), and even real-time dynamic body measurements obtained during the course of the pregnancy.

This ability of the present invention to incorporate dynamic anatomic changes in 3D holographic body imagery improves the underlying medical technology. In the example of a patient scheduled for surgery (e.g., breast cancer patient undergoing mastectomy), the present invention can be used to assess how anatomic change variations will affect preoperative selection. Images of the patient can be analyzed with new data regarding the patient's changing anatomy, and the 3D visualization module 106 can provide potential post-operative complications based on the analyzed range of anatomic variability.

One example is post-operative edema (i.e., soft tissue swelling) which commonly occurs after lymph node resection in the setting of mastectomy which results in lymphedema and varying degrees of swelling to the involved extremity. Using the present invention, the 3D visualization module 106 can show 2D and/or 3D simulations of varying degrees of post-operative edema to provide the patient with a dynamic experience of how body form and image may change, as well as how this anatomic variation may interact with extraneous items such as clothing. The same principles can be applied to therapeutic items (e.g., compression sleeve), in order to determine how a given item will impact these post-operative change (e.g., lymphedema). The ability to dynamically assess this interaction could allow an end-user to virtually compare different item options (e.g., type of item, manufacturer, style, size) in order to assess which option would be best suited for their own individual body form and the specific anatomic variation of concern.

In the previously cited example of a breast cancer patient who is scheduled to undergo mastectomy, the historical data contained within the holographic database 113 can be used by the module 106 to educate, predict, and assist in post-operative treatment and patient management. As an example, suppose the patient is considering three different breast surgeons to perform the mastectomy. The 3D visualization module 106 can record the three surgeons and how they would approach the surgery, providing the patient with complete information on how the surgeries would be done, the variations between the surgeons, and the variations in outcome, which would allow the patient to make important decisions in their healthcare.

In one embodiment, temporal and/or physiologic change in external and/or internal anatomy represented by 3D imagery provided by the 3D visualization module 106, can be used for dynamic intervention by healthcare providers. To illustrate how dynamic 3D holographic data can be used, in an exemplary case, an unidentified person (designated “patient”) who is found unconscious in a parking lot by a bystander resulting in a 911 call. When the emergency medical technician (EMT) arrives, the patient is found to be in severe respiratory distress, which on closer physical examination (i.e., auscultation) is characterized as bronchospasm. Since the patient has no identification readily available, the first responders attempt to identify him through biometrics. This is done by scanning his fingerprints into a portable fingerprint reader, with the resulting data electronically transmitted to the nearby hospital emergency room (ER), which runs the scanned fingerprint data through a central database, which identifies the patient as John Franks, a 60 year-old male with an accessible electronic medical record.

When the electronic medical record (EMR) of John Franks is reviewed by the emergency room (ER) physician, it is learned that Mr. Franks has been diagnosed as having severe asthma resulting in several prior hospitalizations. In addition, he has a prior history of right lung cancer resulting in a right pneumonectomy (i.e., surgical resection of the right lung), which has left him with a single left lung. The combination of severe asthma and a single remaining lung has resulted in a severely tenuous respiratory status which has resulted in cardiorespiratory arrest on 3 prior occasions when his asthma is acutely exacerbated. Included in Mr. Franks' electronic medical records are a number of laboratory data (including arterial blood gas data), clinical tests (including spirometry), and medical imaging exams (including CT exams).

Based on the “in field” clinical assessment and vital signs obtained by the EMT along with the historical records from EMR, the ER physician (Dr. Jones) diagnoses the patient to be in respiratory arrest due to asthma induced bronchospasm. Dr. Jones relays the diagnosis to the EMT and recommends administration of epinephrine followed by emergent intubation before attempting transfer (which will take 20 minutes by ambulance). Since the EMT has limited expertise in intubation and the conditions are certainly less than ideal, Dr. Franks recommends that they employ 3D holographic assistance for the intubation procedure, which will be technically challenging in lieu of the bronchospasm, asthma, and prior pneumonectomy.

The 3D holographic assistance (i.e., image guidance) performed by the 3D visualization module 106 of the present invention, can utilize prior anatomic data from the patient EMR to create a virtual 3D anatomic roadmap, which if integrated with visualization aides (e.g., goggles, glasses) can assist the end-user (e.g., EMT) in performing the procedure (e.g., intubation). In addition to the baseline “normal” anatomic data, the 3D holographic guidance of the 3D visualization module 106 of the present invention can also integrate changes to the baseline anatomic data (which can be physiologic or pathologic), which reflect transient or permanent changes in patient anatomy, which may be the result of physiologic change, temporary (i.e., short term) pathology, or permanent pathology. In this particular case, both temporary (i.e., asthma induced bronchospasm) and permanent anatomic change (i.e., pneumonectomy secondary to lung cancer) require data input and analysis into the database 113 and analysis by the 3D visualization module 106 to provide 3D holographic guidance to accurately reflect the patient's current medical state and anatomic variation.

In the present invention, there are a number of methods which can be employed to incorporate the available imaging data (which may be current and/or historical) into the 3D holographic guidance system database 113. One method is to utilize a single imaging dataset (e.g., most recent volumetric CT exam) and from this dataset, the 3D visualization module 106 can create a 3D anatomic map for the specific medical application and patient of interest. Alternatively, the 3D visualization module 106 and system 100 can incorporate multiple “same type” imaging studies, which would combine data from multiple “same type” imaging datasets (e.g., multiple CT studies) to create “composite” 3D holographic imagery. Another option is to for the 3D visualization module 106 and system 100 to combine imaging data from multiple ‘different” imaging datasets to create a “disparate” multi-study 3D holographic image representation. In this latter example, different types of imaging datasets (e.g., CT, MRI, X-ray) may be electronically combined to create an all-inclusive 3D anatomic representation.

Since multiple imaging datasets may provide variation in data due to physiologic, pathologic, or iatrogenic change; these variations in anatomy can be directly incorporated by the program of the 3D visualization module 106 into the 3D holographic “map” to assist in the end-user in prospectively identifying the potential for anatomic variability which may be directly relevant to the manner in which it is being used (e.g., intubation).

For this example, in which an emergent intubation is being performed “in the field”, anatomic variability in tracheobronchial anatomy due to respiratory variation (i.e., physiologic change), bronchospasm (i.e., pathologic change), and surgery (i.e., iatrogenic change) is very important. Since the current medical state is one of severe bronchospasm, corresponding imaging data from an instance of prior bronchospasm is selected by the program for use, as the primary imaging data source, along with an additional imaging data source which was performed after surgery. This illustrates how multiple imaging datasets can be electronically merged (or fused) to create a composite “clinically relevant” 3D holographic guidance system of the present invention.

In one embodiment, in addition to the “fused” imaging data (which reflects the current medical and anatomic status of the patient), comparative analysis of the full complement of datasets and corresponding report data can be used by the program to identity temporal change to the anatomy (which may be the result of physiologic, pathologic, or iatrogenic change). In this example, program derived measurements of the anatomy in question (i.e., tracheobronchial tree) and/or program derived comparative analysis of the corresponding text reports reveal that diameter measurements of the trachea vary 2.0 cm in diameter when comparing “normal” baseline measurement of 3.5 cm with those during “abnormal” bronchospasm of 1.5 cm. As a result, the 3D holographic image created by the 3D visualization module 106 has incorporated the 1.5 cm diameter measurement to provide the end-user with guidance reflecting the current anatomy in a state of severe bronchospasm.

An additional feature of the present invention is the ability of the program to further modify the 3D holographic image dataset by additional modification reflecting the current clinical status which may not have been present at the time of prior image acquisition. For example, suppose the patient was in “mild” bronchospasm at the time of prior CT. Since using this data might overestimate the tracheal diameter at the current time in which severe bronchospasm is present, the end-user may elect to manually “modify” the derived 3D holographic dataset by inputting the anatomic change of interest. The resulting “modified” 3D holographic dataset would then include both the program derived images and manually directed modifications.

In this exemplary embodiment, once the 3D holographic imagery has been completed by the module 106, the dataset is electronically transmitted by the program to the EMT in the field to assist in the performance of the procedure (i.e., holographic guided intubation), which can be assisted through the use of visual aids (holographic glasses). An additional option is to have synchronous visualization by a second end-user (ER physician), for the purpose of direct interaction (e.g., consultation) during the course of the holographic guided procedure. In this example, Dr. Franks may recommend to the EMT to select a smaller size endotracheal tube to adjust for the decreased tracheal dimeter and recommend that the EMT insert the endotracheal tube a greater distance than normal for selective intubation of the left main stem bronchus since the right main stem bronchus has been surgically ligated at the time of pneumonectomy.

During the course of the intubation, the 3D holographic guidance provided by the program, allows 3D visual assistance to the EMT for accurate placement of the endotracheal tube. In addition, Dr. Franks provides consultation during the performance of the procedure by correlating the path of the inserted endotracheal tube with the 3D holographic visualization map. This illustrates how the present invention can be used to create dynamic 3D holographic imagery which accounts for anatomic variability which may be the result of a variety of factors, and provide image guided assistance (with consultation capabilities) in the performance of medical procedures.

In another exemplary embodiment, a patient is being rushed by ambulance to a hospital emergency room (ER) after being found unconscious in their car on the side of the interstate highway. During the course of medical evaluation including emergent abdominal pelvic CT imaging, the patient (John Smith) is found to be hypotensive (low blood pressure) with reduced hematocrit, acutely short of breath with rapid respirations, and is highly combative. While sedation is required to calm the patient and allow for medical intervention, the medical staff is reluctant to administer sedatives in light of the low blood pressure and altered mental status (i.e., delirium).

The following course of action is taken by the ER attending physician:

1. Placement of two large bore central venous catheters to establish intravenous access and administer fluids and blood transfusions to increase blood pressure and hematocrit.

2. Emergent CT imaging of brain, chest, abdomen, and pelvis.

3. Stat laboratory studies including arterial blood gas, toxicology, complete blood count (CBC), basic metabolic panel (BMP) and prothrombin and protimes (PT/PTT).

The subsequent test results reveal that the patient has abnormally low values of arterial oxygen and hematocrit (suggesting blood loss) along with pneumoperitoneum (free intra-abdominal air) suggesting perforated viscus. Based on this latter finding, the ER physician requests both emergent gastroenterology and surgical consultations to determine whether endoscopy or laparotomy is indicated.

Since the patient has never been previously seen in this hospital, attempts are made to obtain whatever medical records are available. Based on the patient's driver's license information, his wife is contacted who arranges electronic transfer of his medical records which reveal the following medical history:

1. Past medical history: Gastric ulcer with GI bleeding, Colon cancer, Emphysema, Transient ischemic attack (TIA), Carotid artery disease.

2. Past surgical history: Partial gastrectomy, Colon cancer resection, carotid artery stent placement.

Additional data obtained from the ordered CT exams reveal that the patient has severe emphysema and lung scarring, evidence of small prior brain infarcts, and high-density fluid in the peritoneal cavity of the abdomen along with the aforementioned free air.

The patient is determined to be at high risk for surgery and general anesthesia due to the carotid artery disease, severe emphysema, and hypotension. Since the site of perforation is believed to be the stomach, emergent endoscopy is determined to be the best and fastest course of action.

Normally, prior to endoscopy the gastroenterologist would review the abdominal CT exam for identification of overall anatomy and superimposed pathology. The level of granularity of this data is somewhat limited and to some extent operator dependent, since detailed knowledge of medical imaging is to some extent the domain of the radiologist and not the gastroenterologist.

However, using the present invention, 3D holographic imagery can be created by the module 106, using the volumetric data obtained by the combined CT exams of the brain, chest, abdomen, and pelvis; along with supplemental data available in the electronic medical record (e.g., prior endoscopic images, intraoperative photography, physical measurements, arteriography, additional medical imaging studies [e.g., vascular ultrasound, brain MRI, chest CT angiography). This 3D patient hologram can become an integral component of the patient electronic medical record stored in database 113, 114, and can be updated by the program each time new or altered medical data is obtained in the course of a patient's healthcare. In such a case, the sequential 3D holographic images produced over the course of the patient's healthcare could reveal a variety of important data which would be directly relevant to the current diagnosis and treatment plan. These include the following:

1. 3D representation of vascular anatomy for the combined purpose of determining the optimal strategy of required central venous catheter placement, evaluation and localization of the carotid artery stent, and evaluation of intra-abdominal arterial structures supplying the stomach (and potentially contributing to the GI bleeding).

2. 3D visualization of the anatomy which will be navigated during the course of the required upper endoscopy including the esophagus, post-operative stomach, and duodenum.

3. 3D visualization of the nasopharynx, oropharynx, and upper airways which will assist in determining the optimal strategy of intubation prior to endoscopy in order to control breathing and improve oxygenation.

4. Prior physiologic responses to medications used for sedation, which will be required for performance of the endoscopy and treat the patient combativeness. (This latter function is another of the unique applications of the present invention, for it provides the ability to incorporate physiologic data in addition to anatomic data in the comprehensive patient hologram, demonstrating changes in physiology resulting from different forms of treatment.)

In review of this patient-specific holographic data by the module 106 prior to initiating medical intervention, the following strategy is determined by the program, some of which would not have been known in the absence of the multi-organ system holographic data analysis.

1. The patient has marked asymmetry in the size of his internal jugular and subclavian veins, which will be important in determining the best location for central line placements.

2. The patient has an esophageal stricture (i.e., severe narrowing) which will make performance of the endoscopic procedure more technically challenging and dangerous.

3. Temporal evaluation of serial holographic datasets reveal the stomach to be the source of bleeding (which was difficult to determine on a single holographic dataset without the benefit of comparative analysis.)

4. The patient has a severely deviated nasal septum which makes placement of the endotracheal tube difficult, and instead renders the oral placement as the preferred alternative.

5. Post-operative scarring is present in the anterior midline of the upper abdomen in association with prior gastric surgery. As a result, any additional abdominal surgery should take a more lateral approach to avoid the extensive scarring.

6. Previous medical therapies have resulted in transient drop in blood pressure and as a result should be avoided at this time. Pharmacologic and anesthesia consultation should be required to identify the optimal agent for general anesthesia which will reduce the risk of medication related hypotension.

Based upon the analysis of this 3D holographic data by the 3D visualization module 106, the proposed management was adjusted with laparotomy (using an anterolateral approach) replacing endoscopy. Once completed, new data was acquired by the program to produce an up to date post-operative 3D holographic dataset.

In another exemplary embodiment, a soldier in battle gets wounded and is need of emergent intervention since he goes into shock from blood loss. Retrieval of his 3D holographic images with internal anatomy by the 3D visualization module 106, with highlighted medical/surgical history, medications, and historical physiology measurements, provides an in depth “in the field” method of guiding intervention, procedures, and support line placement. By the module 106 superimposing the 3D holographic images directly onto his physical structure, the physician can receive detailed and customized guidance.

In one embodiment of the present invention, the ability of the 3D visualization module 106 to record, store, retrieve, and analyze multifunctional 3D visualization data over large populations of end-users and items (i.e., image sources) provides users with a rich and diverse database which can utilize experiential (i.e., retrospective) data for future (i.e., prospective) use.

In one embodiment, the 3D visualization module 106 records all transactions which have occurred, the identities of the involved parties, and corresponding dates and times. The data recorded by the module 106 in the database 113, 114 by a user's input, is standardized by the module 106, thereby providing a method for comingling data from multiple sources and performing large sample size analysis.

In one embodiment, each time a new end-user, technology provider, or imaging source is introduced, a formal registration process is required, where the 3D visualization module 106 records a variety of data elements which can be used to create a context and/or user-specific profile. These profiles can in turn be used by the module 106 to identify commonalities between different entities, which may assist in a variety of related analyses.

In one embodiment, the first step in the registration process is for the 3D visualization module 106 to capture and record data in the database 113, 114 which can provide the entity with a unique form of identification (e.g., biometrics, alpha-numeric identifier, radio frequency identification (RFID) tag, watermark). This unique identification data can be subsequently used by the program when a future database access is requested (i.e., authentication). Each time database access is requested by a user, time stamped action-specific data is recorded by the program in order to provide a record of all data transactions which have occurred.

In one embodiment, the 3D visualization module 106 can perform various types of data transactions by accessing the referenceable database 113, 114. They data collected by the 3D visualization module 106 may include, at least: age; gender; congenital abnormalities (if applicable); height and weight; surgical history; medical history (including a problem list of active medical disease); medications; activity level; occupational history; and recreation and exercise. Note that all data entries, edits, and sources are time stamped by the 3D visualization module 106 in order to reflect the timeliness and accuracy of the data being used in the analysis.

In one embodiment, in certain circumstances, the identity of an end-user, image source, or technology provider may not be readily accessible (e.g., altered mental status or injured end-user). In these circumstances, the 3D visualization module 106 can access the database 113, 114 for identification purposes, by inputting identification data (e.g., RFID, biometrics) and then searching the database 113, 114 to determine if a data match is made with a previously registered entity. Examples where this application may be relevant include: military, law enforcement, and medical, in which the identity or accuracy of the data source may not be relatively accessible at the place and time of interaction.

In one embodiment, once imaging data has been inputted, the 3D visualization module 106 performs registration of the images in the database 113, 114, in order that the registered images are accessible for future analyses and authorized end-users. The manner in which this image registration process is performed by the module 106 is similar to the registration of end-users, except that the program stores a series of additional data elements related to the specific technology used, the identities of the parties tasked with creation of the data, the identity of the image source, and any associated applications or resources used for image enhancement and/or modification.

In one embodiment, the program can record the imaging data in both its original (and if applicable), processed formats. In the event that compression algorithms are used by the program to reduce the data storage requirements, the compressed data can be reversed by the program (or duplicated in its original format) so as to provide future access and interaction of the dataset in its full multisensory format. If the 3D visualization module 106 determines that additional resources are required for multisensory display and interaction, the identities of these additional hardware/software resources are recorded by the program in the database 113, 114, so as to allow complete access of the multisensory data by future authorized entities.

In one embodiment, authorization to data access and associated data privileges is defined by the creator of the data. In the event that an authorized entity modifies or enhances the original data in any matter or form, both the original dataset and modified imagery are stored by the program within the database 113, 114, with time stamped records along with the identities of the authorized parties. This serves to provide combined functions of data security, quality assurance, data integrity, and historical retrieval and analysis of all relevant data.

Since numerous techniques and technologies are used in the creation of advanced visualization and multisensory data, it is important that the images be consistently and continuously evaluated to ensure data accuracy, integrity, and reproducibility. The first step in the quality assurance (QA) process is the authentication by the quality assurance module 111, of the end-user submitting the data, followed by inspection and analysis of the data by the module 111 to ensure that it meets pre-established quality standards. These quality assurance standards can be established by the user through a variety of sources including (but not limited to) governmental agencies (e.g., National Institute of Standards and Technology [NIST]), scientific organizations (e.g., Institute of Electrical and Electronics Engineers [IEEE]), working groups (e.g., Immersive Technology Alliance (ITA)), international standards organizations (e.g., International Organization for Standards (ISO 9001)), or private entities (e.g., Specialized Enterprise Holography). Regardless of the QA source, the present invention utilizes a well-recognizable and accepted methodology for analyzing the accuracy and integrity of the images being submitted.

In one embodiment, an additional (and unique) method of QA intrinsic to the present invention, is the incorporation of end-user feedback by the QA module 111, which is discussed in detail below. This form of end-user QA utilizes a standardized methodology for end-user feedback via surveys, regarding their individual perception of “data satisfaction”. While this QA data is subjective in nature, it can be pooled by the QA module 111 over large numbers of end-users to identify trends in perceived data quality, which can be applied to data sources on both individual and collective levels. In addition, the standardized QA data can be longitudinal in nature, so that the QA module 111 can analyze data quality over a prolonged period of time.

The present invention can be used in other applications in addition to medical applications. In one embodiment, the present invention provides the end-user with the ability to directly interact with the object of interest, in a multisensory capacity, such as using holographic 3D data in e-commerce.

In one exemplary embodiment, an end-user may wish to compare a variety of products with the intention of a potential purchase. In conventional e-commerce practice, an end-user could search the Internet in order to identify items of particular interest. Once identified, the end-user can visually compare different options, on the basis of static and non-interactive two-dimensional images.

Using the present invention however, the 3D visualization module 106 would allow an end-user to visualize life size representations of the items in three-dimensions at home (or in a store, or in 2D on a screen), along with the ability to supplement the visual display with other sensory input data (e.g., tactile, smell, taste using external systems 22, such as pressure sensors, Whiffers, etc.). For example, if a user was shopping for a sweater, a user could literally get a real-life sense of how the sweater would look, feel, and even smell. In addition, the various options available (e.g., size, color, style) could be modified by the 3D visualization module 106 in real time, effectively creating an interactive multisensory display. The application of this multisensory data interaction would vary in accordance with the context and individual end-user preferences.

In another application, if one was to replace the item of interest from clothing to food, sensory data specific to taste and smell might take on greater importance.

In one embodiment, the 3D visualization module 106 can provide the end-user the ability to customize the interactive experience in accordance with the individual end-user attributes Using the e-commerce example of sweater shopping, the end-user may wish to extend the experiential multisensory data interaction to include his or her own body image, so as to allow one with the ability to effectively ‘try on” virtual clothing, in effect creating a virtual direct experience between the item of interest and the end-user. In this application, an individual end-user's previously inputted personal 3D holographic body image would be employed by the 3D visualization module 106, so as to provide a method for multisensory experience of the item in question directly on the user's own body. As an individual user selects an item of interest, the user would have the ability to superimpose 3D holographic images of the item (e.g., sweater) on the human form (e.g., user's body). This customized interactive experience would be multisensory in nature, so that visual, auditory, tactile (i.e., haptic), temperature, and taste using sensors 22 could be incorporated by the 3D visualization module 106 into the interactive experience.

For example, in one embodiment, miniaturized pressure sensor technology 22 is incorporated directly into the individual end users' 3D holographic body image, in order to detect pressure measurements over different anatomic regions. As an example, if one sweater was to register higher levels of pressure in certain anatomic regions (e.g., armpits), compared with other anatomic areas (e.g., chest), these subtle pressure variations (i.e., specific to the product and individual end-user) could be recorded by the 3D visualization module 106 in the database 113, 114, and relayed to the end-user as a feeling of ‘tightness”. This would provide an end-user with the ability to compare and contrast different product options which are not only specific to their own individual body form but also specific to individual product and its subtle anatomy-specific sensory variations. This ability to incorporate sensor technology directly into the 3D holographic data provides an objective method for dynamically analyzing the context and end-user interaction.

Thus, in the example of sweater shopping, this primary sensory data of interest would be visual and tactile. By incorporating the ability to dynamically modify systems 22 specific to options related to the “item”, the end-user could literally experience how the different options (e.g., sleeve length, fabric composition) would look and feel, simplify by selecting and modifying the various options available. This application of the invention would literally create the ability to experience multiple 3D holographic images in combination with multisensory data input, and provide dynamic interactive capabilities in which the end-user can modify the 3D holographic images with the purpose of creating and experiencing variable real-life scenarios.

In one embodiment, the ability to dynamically modify the product can also be extended to external (e.g., environmental) factors as well. For example, in sweater shopping, the end-user may wish to dynamically change the local environment (e.g., temperature change, rain) in order to assess how the product/end-user interaction is modified by environmental change. In this interactive application of the invention, the product (e.g., sweater) and human form (e.g., individual end-user body image) may remain fixed while the end-user may adjust environmental conditions using external systems 25 such as the HVAC system 25. As these environmental conditions change, the derived multisensory data (e.g., sweater fit, absorptive qualities) would adjust in a manner commensurate with the environmental change input.

As an example, the initial interactive sensory experience may be predicated on room temperature (e.g., 70 degrees). As the temperature is lowered (e.g., 50 degrees) using the HVAC system 25 as instructed by the 3D visualization module 106, the resulting changes in perceived body warmth and feel of the fabric may be altered so that the end-user can get a sense of how the specific product responds to environmental change on the specific body form of the individual end-user.

In the example, if the end-user elects to purchase one of the sweaters during the course of their virtual shopping and holographic data interaction, they would have the unique ability to input QA data into the database 113, 114, accessed by the QA module 111, that contrasts their ‘virtual” and “real life’ interactions (in this case relating to the sweater they have purchased). This QA data provides a method for directly measuring multisensory data quality between the virtual and real-life interactions. In one example, the end-user may determine that the visual image data between the holographic and real-life displays are nearly identical and as a result input a high QA measure for ‘visual” sensory data. On the other hand, the same end-user may determine that the interaction with the virtual dataset is markedly disparate from the real-life interaction as relating to “tactile” sensory data. This provides a unique ability to not only compare an end-user's perception of data quality between ‘virtual” and real life” interactions, but also record QA data measures on an individual sensory basis, in the setting of multisensory data presentation states.

In one embodiment, in addition to pooling QA data from multiple end-users for a single data source, the analysis by the QA module 111 can also extend to pooling QA data from multiple “related” data sources. As an example, the QA measures for the sweater used in the example of virtual shopping can be combined by the QA module 111 with QA data from other sweaters for the same product provider. This would provide contextual QA data for multiple data sources from the same provider, which would provide valuable feedback to both the data provider as well as prospective shoppers.

In one embodiment, the company tasked with creating the 3D datasets (for example, on a contractual basis from the product provider) would greatly benefit from having QA customer feedback as to the quality of their datasets not only from this product and content provider, but other content providers for whom they provide 3D imagery.

In one exemplary embodiment, if the image provider was to introduce a new and/or refined technology for data acquisition or processing, this end-user QA feedback by the QA module 111 would provide them with valuable QA data “before and after” the technology intervention, thereby providing them with an important QA metric analyzing the perceived change in data quality before and after the technology intervention.

In another exemplary embodiment, an end-user (i.e., virtual shopper) may interact with a number of holographic datasets specific for the application of interest (e.g., sweater shopping). As the end-user interacts with individual datasets, they would be provided by the 3D visualization module 106 with the option to record their subjective level of feedback relating to the perceived quality of the holographic data, which can be recorded both in isolation or tandem. In the isolated use case, the end-user would input a standardized QA measure for a single data source for recording by the QA module 111. In the tandem use case, an end-user may record a series of individual QA scores, using the QA module 111, relating to multiple data sources (which in this case may entail a number of data sources of different sweaters they are interacting with). This provides one with the ability to record individual end-user QA data on an individual and/or comparative basis.

In one embodiment, a method for integrating standardized objective and subjective measurements into the QA analysis can be performed with the QA module 111, the data which can be recorded and analyzed over time, fractionated on the basis of different sensory components, pooled among large samples of end-users, with direct comparison made between ‘virtual” and “real’-life” data interactions, which is used to analyze the impact of technology interventions.

In one embodiment, the following are a list of standardized QA metrics which are recorded in the QA database 113, 114, along with a representative example of a standardized methodology for subjective QA assessment, which can be directly linked to the individual end-user, context, and technology by the QA module 111. The metrics include:

1. 3D data source (i.e., subject of 3D visualization): a) type of application (e.g., e-commerce, aerospace, military); b) identity of image source (i.e., unique identifying data); c) applicable multisensory data (e.g., visual, tactile, auditory).

2. Technology provider: a) identity of data provider (i.e., technology provider for 3D data); b) type of data visualization (e.g., holography, virtual reality); c) technology in use (software (e.g., image processing), hardware (e.g., glove)).

3. End-user; a) identity of end-user (i.e., unique identifying data); b) profile characteristics (e.g., occupational status, demographics, compliance); c) historical use (e.g., prior experience, patterns of use, data analytics).

4. QA Metrics: a) objective data; b) subjective data; c) mitigating factors (e.g., environmental, display device); d) individual and collective QA measurements (i.e., breakdown of individual sensory components versus single all-inclusive QA measurements); e) comparative assessment (e.g., virtual versus real-life, change in technology). (Note: all data recorded is subject to end-user authentication/verification and is date and time stamped.)

In one embodiment, representative examples of subjective QA methodology include: 1) Poor quality of data, no direct correlation to real-life experience; 2) good quality data, significant differences to real-life experience; 3) very good data quality, small yet easily perceptible differences to real-life experience; 4) excellent data quality, minimally lacking to real-life experience; 5) outstanding data quality, comparable in all aspects to real-life experience.

As noted above, in one embodiment, subjective methods for holographic image quality can be derived from end-user feedback, as recorded in the holographic database 113, 114 and analyzed over time by the quality assurance module 106, from the large population of end-users. These subjective QA measures can be mandated by the quality assurance module 111 to require end-user feedback each time the present invention is used. As an example, if the end-user is utilizing the application for e-commerce they will make purchasing decisions in large part on the basis of holographic multisensory data analysis. If for example they are shopping for a sweater and provide subjective data feedback on the basis of the sweater's holographic data which is contradictory to prior data measurements (which can be supplied by the provider of the image source as well as other shoppers), then the quality assurance module 111 would flag the input as a possible QA outlier requiring additional QA testing.

Another example of subjective QA assessment in e-commerce is when a shopper elects to purchase an item based upon the combined (i.e., superimposed) holographic data of the item and their personal body image. Suppose in the course of sweater shopping the end-user (i.e., shopper) determines that aesthetics of the sweater along with its body fit were both deemed to be desirable and as a result, justified purchase of the item in question. Upon receipt of the sweater however, the customer was disappointed in the item itself (e.g., appearance) or it's fit on his/her body. This would indicate that an inherent flaw existing in the purchasing process which could in theory be attributed to a number of variables which include (but are not limited to) inaccurate holographic data intrinsic to the sweater, inaccurate holographic data intrinsic to the person (i.e., holographic body image), poor quality manufacturing of the item (which is distinct and separate from the holographic data), or improper size. Since the return policy mandates that specific information be submitted at the time of the requested refund, the shopper would provide the specific reason for the return and this information would subsequently be recorded in the holographic database 113, 114 by the program, and subsequently investigated using the quality assurance module 111 to determine the exact source of the discrepancy. The ability to analyze stored holographic data is an important resource for identifying QA trends relating to individual applications being used, image data sources, technology providers, and end-users.

Examples of QA trends (which would likely be missed in the absence of large numbers of data points) derived by the quality assurance module 111 may include end-users (i.e., shoppers) whose holographic images are outdated, and as a result inaccurate, holographic image providers whose technology is consistently flawed, product vendors who are not accurately updating holographic images to demonstrate design or manufacturing changes, and software applications which do not accurately superimpose or synchronize item and body source images. The net effect is that the combined ability of correlating holographic data with end-user feedback and experience provides an important adjunct to holographic QA, in conjunction with technical QA image analysis.

In one embodiment, the present invention simulates real-life experience, and this is used as the reference point for measuring data quality and satisfaction of use. The QA data can also be used as an important quality improvement resource by providing quality analytics to providers for the purpose of quality improvement. In addition, other authorized end-users can utilize the QA and derived analytics for improved decision making. Comparative QA analytics by the QA module 111 can also be used to identify and group end-users in accordance with similarities in QA perceptions, with the goal of using QA data as another metric for creating end-user profiles. This can be used by the QA module 111 to create “modified QA scores” in accordance with an individual end-user's grading tendencies.

As an example, if one end-user routinely tends to provide higher QA scores relative to their peers (e.g., mean individual QA score of 4.2 versus group mean score of 3.2), this mathematical score modification can be presented by the QA module 111 along with the raw QA score data, so as to provide insight to the user as to how individual end-users' QA scores vary relative to the population at large. This may prove to be beneficial in decision making, when an end-user is utilizing prior QA data to assist in decision making (e.g., e-commerce).

For example, in e-commerce purchasing, the user may see two items of interest which fulfill their search criteria and in order to differentiate the two options, they may render their final decision (i.e., purchase) on the basis of the higher QA score of the two candidates. If one product's QA scores are artificially inflated (or deflated) by a QA outlier, this data can be highlighted by the QA module 111 to assist in the decision-making process. Along these same lines, QA scores which specifically compare virtual to real-life QA scores may be selectively provided by the QA module 111, along with the frequency of “returned” items after purchase.

In one embodiment, in addition to the end-user feedback being used for product modifications, the same feedback can be used to assist providers in future product designs and/or enhancements. By the module 106 recording all feedback in the holographic database 113, 114, each individual item would have its own “feedback” data, which when pooled over time by the module 106 among multiple end-users, could provide valuable information for new product development, product refinement, redesign, and comparative analysis of competitors' products. As new and/or redesigned products are introduced, automated alerts and product links can be transmitted by the 3D visualization module 106 to selected end-users which may be identified by a number of search criteria including (but not limited to) end-users who have previously viewed and/or purchased similar products, or customers who have provided previous feedback, customers in virtual shopping networks with similar product interest and/or purchases. The net result is that both end-users and providers can identify source images of interest based upon analysis of the 3D visualization module 106 and utilize this information for direct communication and marketing.

In one embodiment, in the case of e-commerce, the present invention provides additional applications, specifically relating to the ability to dynamically modify image source data while providing feedback to the holographic image provider. In the example of “virtual” sweater shopping, an end-user is interacting with a specific sweater option on her personal holographic image and has a number of concerns and/or questions before finalizing her decision. These could relate to a number of variables such as fabric choice, style, cut, length, etc.

In one embodiment, the present invention provides a standardized method for relaying this request and/or modification back to the provider for the purpose of improved customer satisfaction with the product of interest. This feedback can be supported by a variety of data input methods including (but not limited to) text, graphical, pictorial, or drawing.

As an example, suppose the end-user (i.e., virtual shopper) wishes to modify the sleeve length (e.g., increase by 2 inches), change the fabric choice (e.g., from polyester/cotton blend to 100% cotton), or change the zipper to buttons. In addition to inputting these requests through text, the present invention could also support graphical input in a variety of ways. Examples of ways to request lengthening the sleeves might include the user highlighting the sleeve and inputting+2 inches, clicking on the sleeve and dragging to expand the length by 2 inches, or using an electronic writing utensil to draw an additional 2 inches onto the end of the sleeve.

In addition to the input request, the 3D holographic image could be synchronized by the 3D visualization module 106 with the inputs, to digitally incorporate the requested modifications to the original 3D holographic image. If the modified image accurately reflects the requested changes, the end-user would then “accept modifications”. The resulting “modified” 3D holographic image would then be transmitted back to the vendor by the program for review to determine whether the requested changes are available, whether they could be manually performed (i.e., tailoring) and if so at what additional expense, or whether future product redesigns are planned for to accommodate the request. If, on the other hand, the modified image does not accurately reflect the end-user's desired modifications, they could select the “additional modifications” option and input additional information until the modified image accurately reflects their request.

In one embodiment, in addition to direct vendor feedback, these “modified” 3D holographic images can also be used by the 3D visualization module 106 to generate a broad query of the 3D holographic database 113, 114 to determine whether comparable products of other vendors are available which better match the desired modifications. Using artificial intelligence and computerized image searching techniques (e.g., content-based image retrieval, reverse image search) the 3D visualization module 106 can identify candidate 3D holographic images which most closely match the “modified” 3d holographic image of record. Once these candidate images are identified, they can be automatically presented by the module 106 to the end-user for review and/or action. The end-user could elect to reject the presented image, accept the image “as is” (e.g., purchase the item), or input additional modifications for vendor feedback (e.g., change color from dark blue to black). In the event that the end-user was to “accept” a retrieved image option from the automated database 113, 114 retrieval, they could then “try on” the new item by superimposing this onto their personal 3D holographic image for the purpose of analyzing how its looks and feels on their virtual body image. All data generated through the combined processes of image modification, end-user input and feedback, and automated image search and retrieval would be recorded by the 3D visualization module 116 in the holographic database 113, 114 for future analysis.

In one embodiment related to e-commerce, an end-user can review prior search requests of other end-users for similar items of interest. End-users may even form “virtual shopping networks” with friends or peers with similar end-user profiles. When doing so, the actions (and associated data) of end-users within these virtual shopping networks can be shared with other authenticated shoppers to assist them in their virtual shopping.

As an example, one bridesmaid may identify a pair of shoes which match the bridesmaid dress. Since she knows that other bridesmaids in the wedding party may be interested in the same pair of shoes, she may request that the link to the shoes she has just purchased be forwarded to the other identified bridesmaids. If these bridesmaids are registered in the holographic database 113, 114 an automated alert will be sent by the program to them notifying each of them of the virtual shopping “friend” request. If accepted, they would then be provided with a link to the item of interest along with any accompanying information recorded by the purchasing bridesmaid. If a bridesmaid elects to “try on” the selected shoes, their personal 3d holographic image would be “fitted” with the shoes along with multisensory feedback related to the fit and pressure points. If the 3D holographic imagery supports motion functionality of the human 3D holographic image, the bridesmaid could go one step further and “virtually walk” in the shoes, while simultaneously wearing the selected bridesmaid dress (by superimposing the holographic image of the bridesmaid dress on the holographic image of the bridesmaid). This example illustrates several unique features of the invention including the ability to share search data (anonymously or trough invitation), combine multiple items in a virtual fitting, and evaluate the “fit” of a virtual item through active movement of the human 3D holographic image.

In one embodiment, the present invention utilizes the 3D holographic images of “interested customers” to assist in product design and creation. In the prior example of virtual shoe shopping, a bridesmaid selected a pair of shoes to match the bridesmaid dress and shared this purchase and shoe selection electronically (via text, email etc.) with fellow bridesmaids. Suppose out of the 6 bridesmaids only 3 could successfully “fit” into the shoes due to design constraints for wide feet. The corresponding data from the 3 bridesmaids who had poor virtual fittings are stored in the product database and subsequently can be used by the shoe manufacturer to create a similar shoe designed for wider feet. These redesigned wide shoe styles can then be tested by the 3D visualization module 106 on the 3D holographic images of the bridesmaids who rejected the original shoe to see whether they now fit, and if so, how they would be perceived by the bridesmaids. The vendor may send an automated alert via email or text, etc., to the bridesmaids in question notifying them of the shoe redesign and request for virtual fitting, along with an inducement, such as a 25% electronic coupon if purchased. This illustrates how the data contained with the holographic database 113, 114 can be used by the 3D visualization module 106 to assist in product design, identify customers of interest, and assist in targeting marketing.

Depending upon the specific application in which it is being used, the sensitivity of the 3D holographic body image to subtle imperfections may vary. If for example, the application is being used for e-commerce, specifically for the purchase of a hat then slight imperfections in the 3D holographic body image may not be consequential since the fitting of a hat is both consistent over time and not significantly affected by minor age or weight change. On the other hand, the purchase of a pair of pants would be highly dependent upon age and weight change since relatively small changes in waist size may be of consequence in optimizing proper fit.

As a result, when an end-user uses the invention by signing into the application (which in turn opens the user-specific profile) and selects the specific function of interest, a rules-based algorithm by the 3D visualization module 106 will determine the need for update to the 3D end-user holographic image. If the time since the last update and/or selected application meets the threshold for the 3D hologram to be recreated, then an electronic notification will be issued by the 3D visualization module 106, alerting the end-user as to the necessity of hologram updating. Examples of triggering events may include significant change in height or weight, significant change in health status, interval surgery, extended time since the last update, or incongruence between holographic images of the individual end-user's body image hologram and that of external items (which in effect means that items which are supposed to fit the body image of record do not). For quality assurance purposes, when a reissuance of body hologram is deemed mandatory, the quality assurance module 111 of the system 100 may essentially lock out the end-user from future use until the required holographic update has been satisfactorily completed.

Periodically, it is important to reassess the accuracy of the holographic data contained within the database 113, 114, since inaccurate data will have a negative impact on performance, data reliability, and the accuracy of the derived analytics. Both objective and subjective methods of QA can be incorporated for use by the 3D visualization module 106 for the purpose of measuring holographic image quality using standardized measurements, which are subsequently recorded by the program in the holographic database 113, 114. A variety of technical analyses are available including (but not limited to) diffraction efficiency, peak signal to noise ratio, and interferometry. Such methods have been previously cited in the both scientific literature.

In one embodiment, instead of just focusing on one item and a user, the present invention can be used to analyze multiple holographic images simultaneously, which can include a myriad of subject matter (e.g., items, people, animals, environments) and the interactions which occur between them. In one example, an end-user (Marge) is interested in purchasing a television for a family room in the house and wishes to not only determine which television is best suited for their needs but also determine the best physical location of the television based on the room dimensions, layout, and existing furniture. In the current environment, the television is positioned within an entertainment center, but this may be obsolete given the switch to a flat screen television. In addition, Marge's husband (Joe) has a visual impairment in one eye (due to remote trauma) which may influence the positioning of the television and/or the furniture (specially his recliner chair). In order to make an educated decision, multiple factors should be taken into account including room dimensions and layout, existing furniture, television size and specifications, visualization constraints, and lighting. In order to accurately perform this assessment, individual and collective holographic displays for each of these factors as well as the collective room are created by the 3D visualization module 106 based on the multiple factors and inputs.

In this example, the user's evaluation of the television 3D hologram would not only include the footprint and appearance of the television but also its visual presentation. By taking into account its visual properties (e.g., pixel size, display technology), the 3D visualization module 106 can incorporate 3D holographic imagery into the television display. In addition, the manner in which this television display data is visualized by persons in the room can be simulated by taking into account display distance, visual acuity, and lighting.

In the specific example of Joe, his impaired vision in one eye can be incorporated into the 3D holographic imagery, by displaying visual differences in the television image between both eyes. If one was to reposition Marge and Joe at different positions in the room and different distances from the television, the resulting display differences could be represented by the 3D visualization module 106 in the 3D holographic television display to simulate each person's vision.

In this example, both television position and lighting changes can also be incorporated into the 3D holographic analysis by the module 106, with variations in natural and ambient light factored into the analysis. The 3D visualization module 106 can incorporate drapes, blinds, and curtains into the analysis over different times of the day (with subsequent changes in natural light) to simulate visual changes. If one was to compare a number of different television options, the factors for analysis would include size, appearance, visual presentation, and positional change (of both the television and people). This example demonstrates how the 3D holographic display and analysis can take into account multiple source images and the interaction effect which occurs between them with environmental, physical, and locational differences are factored into the analysis.

In one embodiment, an exemplary general method of practicing the present invention is described as follows.

The end-user logs on to the system 100 (end-user authentication). If the end-user is not recognized or authenticated, formal registration is denied. If the system recognizes and authenticates the end-user, formal registration or re-authentication is implemented prior to system use.

Once authenticated, if the end-user's profile as retrieved from database, is missing or exceeds defined time limits (i.e., from last authorized use), additional data input is requested from the user to update end-user profile, as well as any data from the internal databases 113 or external databases 114, which are automatically retrieved by the 3D visualization module 106.

Once the end-user profile has been deemed up to date and complete, the end-user enters options for use and desired actions. If the desired user action exceeds available data, additional data requirements may be necessary for the requested application to be fulfilled. (i.e., end-user requests application specific to a specific anatomic region which requires more detailed 3D anatomic representation).

The 3D visualization module 106 obtains additional anatomic data commensurate with the desired application from any databases 113, 114, equipment 21, sensors 22, and external equipment 25 (e.g., 3D pictures/video, detailed measurements, compositional analysis),

Once new and/or additional data is obtained and verified by the 3D visualization module 106, the requested application can be initiated by the module 107. Correlative data and/or resources available in databases 113, 114 are retrieved by the module 106 to assist in the requested application. The module 106 then presents the end-user with context-specific data/resources retrieved from the databases 113, 114.

The end-user then enters feedback as to the relevance of the data presented and any desired modifications for performance of the specific application requested. The 3D visualization module 106 then provides a series of questions, and answers and feedback are entered for the module 106 to align the interests and preferences of the end-user with the application being requested, using data analysis with results presented in the visual display 102 for the user.

Once end-user/computer interactive communication and analysis is completed, the 3D visualization module 106 searches the database 113, 114 to identify prospective candidates or items to fulfill the desired application. The data retrieved from the database search is presented to the end-user for review and feedback in accordance with the defined application, end-user preferences, and requested presentation state.

The end-user reviews the options and provides feedback for each of the presented display options. If additional data is required for satisfactory task completion, the 3D visualization module 106 can search any databases 113, 114 to comply with the end-user data request. If data is available, it is retrieved by the module 106 and presented for review. If data is not available, the end-user is notified by the module 106 of the data insufficiency which could elicit a new request by the user for use or continuation with available data.

Based upon data selections and feedback from the end-user, the data is applied by the module 106 and presented for end-user review, selection, and feedback. The end-user is presented by the module 106 with a variety of options for further action (e.g., purchase, query service provider, search for additional related options, enter new request for analysis).

Once the end-user has completed the search and analysis, the application is closed by the user and the module 106. All accompanying data is recorded in the database 113, 114 by the module 106 specific to the end-user and context.

In the event that a successful task completion is recorded, end-user feedback is requested by the 3D visualization module 106 specific to the degree of concordance/discordance between the virtual and “real life” analysis. This “virtual/real life” data feedback is incorporated into the database by the module 106 for iterative refinement of the data and derived analytics.

In order to illustrate the embodiments of the present invention, an example of e-commerce follows. In this example, a female end-user (Jane Doe) is preparing to attend her 20 year high school graduation and wants to shop for a head to toe outfit which will present her in the most positive light. The last time she has used the proposed invention for clothes shopping was 2½ years ago and this was specifically for workout attire. When presented with the menu of available applications, Jane selects the application of “e-commerce” from the application on the electronic device (i.e., cell phone, computer), which in turn provides a number of prompts related to the myriad of e-commerce options. The following items are selected by Jane: 1) E-commerce, 2) Clothing (female), 3) Formal attire, 4) Individual options selected: a) Dress, b) Shoes, 5) Additional items (fashion related): a) Hat, b) Handbag, c) Scarf, d) Jewelry.

For each individual item requested, a series of questions are presented to Jane by the 3D visualization module 106 to provide feedback specific to that item and related variables. As an example, for hat, Jane is requested for feedback specific to her desired hair style, hair length, hair color, and color/style of synchronous attire (e.g., dress, jewelry). In addition, Jane is requested to provide a hierarchical order as to the relative importance of each individual item/application being requested. In this example, the dress is the primary and most important item of concern and as a result, may influence selection of other items (e.g., shoes, hat, scarf). Based upon this feedback, the first item for analysis is the dress and the resulting secondary searches will be predicated upon the dress selection.

Before being presented with a number of dress selection preferences (e.g., length, style, color, material) by the module 106, it must first be determined whether Jane's stored physical data is up to date and accurate. For the selected application (i.e., dress purchase), accurate fitting is an important component of successful application, so any change in body size/weight is imperative in creating a lifelike 3D holographic representation as well as determining the optimal dress fit. If retrospective analysis of the end-user database reveals that the last time Jane's physical attributes were recorded and analyzed was 2½ years ago then a renewed analysis may be required, specifically if the requested application/s are sensitive to minor variations in body habitus change which could occur in association with a wide array of situations including (but not limited to) weight gain or loss, changes in the type and/or frequency of exercise, physiologic changes (e.g., menopause, recent pregnancy), disease states (e.g., hypothyroidism, cancer), medications (e.g., hormonal replacement therapy, testosterone), alterations in lifestyle and/or occupation (e.g., increased/decreased levels of daily activity), or surgery (e.g., mastectomy, gastric bypass surgery).

While shopping for shoes may be relatively unaffected by minor weight changes, shopping for a dress may be highly dependent on subtle weight change and/or redistribution in body fat/muscle. In addition, when the desired application is highly sensitive to subtle change in localized anatomy, mandatory reassessment of anatomy may be required. As an example, if one is being fitted for a ring, it may be a mandatory requirement to re-create a 3D hologram of the relevant anatomic region (e.g., ring finger) each time a new purchase is being made, and may require multiple measurements during different times of the day. For example, if a person's hand tends to swell as the result of medication, activity, or underlying disease during the course of the day; it may require multiple measurements to accurately reflect the intra-day anatomic variation and utilize this data for accurate sizing. This may be reflected in the resulting 3D holographic images as customary or expected end-user variability. This is a unique application of the invention and provides important information regarding overall appearance which are ‘expected” for the individual end-user and may prove to be important in performing the application of interest.

In order to accurately determine whether any important changes beyond the end-user's baseline justify additional and/or repeat measurements, an end-user specific medical datasheet is provided by the module 106 to assist with documentation and analysis of temporal change. This user-specific medical datasheet records a number of medical data which can be periodically edited for the purpose of determining when and if additional end-user data is required. The data includes the creation of context and user-specific 3D holograms, etc.

The validity of the self-reported data can be periodically assessed by the quality assurance module 111 for accuracy (i.e., quality assurance) based upon extraneous data sources, including (but not limited to) the patient's electronic healthcare record, physician reports, pharmacy records, imagery (e.g., photography, video) 21, 22, and the 3D holographic data 22. This latter data is of particular importance because it serves as an independent quality assurance method of assessing whether the self-reported data matches the created 3D holographic images. In the event that trends are observed in repeated data disassociations, an external review of the 3D holographic technology and image processing can be performed to determine the accuracy of the technology being employed.

In this example, a number of factors justify repeat measurements including the time interval since measurements were obtained and the specific application being requested, answers to directed questions (e.g., weight change, alterations in exercise). A variety of measuring devices 21, 22, 25 and technologies can be utilized including (but not limited to) video, photography, physical measurements (performed by an authorized provider), 3D medical imaging technologies, and calibrated measuring devices (e.g., scales, laser guided measurement tools).

Once the required data is recorded and validated by the module 106, the corresponding data is transmitted by the module 106 to the end-user medical database and subsequently used to create a series of updated end-user 3D holographic images (These may include a combination of full body or individual anatomic components (e.g., extremity, torso, head).

In one embodiment, microscopic holograms can be created for analysis on a molecular level. The corresponding holographic images of the anatomy of interest are then used for performance of the requested application(s). In the above example, 3D whole body holographic images are used in the analysis of electronic dress shopping. The end-user inputs desired specifications related to the item in question (e.g., dress style, color, fabric choice, etc.) and the program cross references the user-specific input data (which includes their individual preferences, medical data, and 3D anatomic measurements) with the bevy of e-commerce data.

One way to narrow this search is for Jane to select a few sample dresses from an on-line search of dress vendors to select a few representative examples of desired dresses. The program can enhance the search process through the integration of advanced artificial intelligence such as deep learning algorithms, advanced visual search tools, and image recognition software.

Once search candidates have been identified and categorized (i.e., in accordance with their degree of concordance with the defined search parameters and user-defined preferences), computer-derived 3D holographic images of the search candidates (i.e., dresses) are then superimposed on the 3D holographic images of the specific end-user (i.e., Jane Doe). This provides a 3D multi-sensory visualization tool in which Jane can not only visualize how each dress would appear on her body but also how it would feel (or if applicable provide other sensory input including smell, taste, sound). The module 106 would also provide Jane with the ability to make a variety of modifications to her 3D holographic image, for the purpose of visualizing how body/appearance changes would be manifested in the dress fit and look.

As an example, suppose Jane wants to see how a weight gain of 20 pounds would alter the appearance and fit of the dress. By inputting the modifications of interest, the 3D visualization module 106 could render the adjustments to the 3D holographic image and superimposed dress related data. One could even embed mechanical pressure sensor technology 22 into the 3D holographic imaging technology to provide pressure data input as it relates to the fit of the dress on the 3D holographic body image.

Suppose for example, the initial fit of the dress (i.e., before weight gain) should relatively small areas of increased pressure (i.e., areas of relatively tight fit) in the arm pit and upper thigh regions. As the 3D holographic image incorporating the 20 pound weight gain is created and analyzed by the module 106, the corresponding increases in mechanical pressure in these regions (as well as additional anatomic regions) can be identified and reproduced, allowing Jane to literally feel how the dress would fit on her body both before and after the weight gain.

In addition to computerized simulation of appearance changes (e.g., 20 pound weight gain), the module 106 can provide temporal changes in 3D holographic imagery of the historical end-user profile to show how each individual end-user's holographic imagery can changed over time. Suppose in this example, over the course of recorded time (e.g., 5 years), Jane has had fluctuations in weight totaling 30 pounds. By retrieving the 3D images over the designated time period, the holographic images used in the current application can directly reflect interval changes which have previously been recorded. This provides an important resource to enhance 3D holographic image modification and the derived computerized simulation of requested changes.

Once Jane has been provided with the multisensory product data and corresponding 3D holographic images superimposed on her own anatomic 3D holographic image, she can comparatively shop by literally seeing and feeling each individual dress on her 3D holographic image. She can even go one step further by modifying the product of interest, both through physical and environmental change. For physical change, she could make adjustments to the dress (e.g., lengthen hemline, change fabric composition). For environmental change, she can adjust the temperature (e.g., introduce excessive cold or heat) to see how the feel of the dress and body temperature responds. By doing so, the 3D holographic multisensory data and derived analytics become interactive in nature. An additional physical interaction effect can be performed by testing the response to an external spillage of fluid (e.g., spilled wine), which can provide data related to how the fluid is absorbed, how it looks and feels, and how the stain might appear and respond to stain removal).

Another application of the present invention is the ability for Jane to interactively query both the database and manufacturer of interest. As an example, Jane has identified three potential dress candidates which fulfill her individual criteria but has a few additional questions to answer before making a final decision. In the case of the first dress, she wants to know what other color options may exist in her designated choice of blue. She can do so by either requesting a search where the module 106 can identify alternative options in blue for the dress or by directly communicating with the manufacturing company through an interactive communication application, in which she can enter her question and communicate directly with a company representative. This customer/company interaction data may prove useful to the company in future product design strategies. In certain situations, the company may provide customized service to accommodate the customer requests (e.g., dyeing dress).

Once the collective process of search, modification, and query has been completed Jane makes an educated decision as to which dress she will purchase. Once completed, she can go on to additional purchases (e.g., shoes, pocketbook, hat, scarf) to complete her ensemble. As each respective purchase is completed, the selected products and resulting holographic images can be used to assist in the next product selection.

As an example, the combined 3D holographic image of the selected dress superimposed on the anatomic image of Jane can be used in comparatively shopping for matching shoes or jewelry. In one example, Jane realizes that the dress she is selecting will be multi-purpose and be worn at both an upcoming June wedding in Florida as well as a business meeting scheduled for February in Minnesota. To coordinate with the Minnesota business meeting, she shops for an overcoat which will go with the dress and be suited for February weather in Minnesota. By inputting search criteria under the category of “Environmental Conditions”, she can then select the options for “winter” along with the date (February 10) and geographic location (Minneapolis Minn.). Using computerized intelligence techniques and historical weather data, the 3D visualization module 106 can provide Jane with an expected range of weather conditions, which she can utilize in enhancing the selection process of the overcoat, in coordination with the dress she has just purchased.

When a product is not selected during the search process, both customer feedback and search analytic data can be presented by the module 106 back to the product provider for the purpose of market research. If for example, Jane elected to discard one dress option on the basis of the fabric was pinching her waistline, this data can be forwarded to the company and design team to assist in future design modifications. This illustrates how the combined user and context-specific holographic image data can be of use to both the product purchaser and seller.

After purchasing the dress, Jane tries it on and is frustrated by the fit of the dress (i.e., too tight in the bust). Since no noticeable anatomic change has occurred in the 1 week period between dress selection and receipt, she is concerned that the 3D holographic technology used was faulty. An important quality assurance component of the invention is the ability to retrieve and analyze retrospective data along in accordance with prospective end-user context specific feedback. In this example, Jane informs the seller that there was a discrepancy between the 3D holographic multisensory data presentation and the actual fit of the dress. In addition to subjective end-user feedback another option is to acquire new objective data which can in turn be correlated with the 3D holographic data used in the analysis. This new objective data can be performed in the same fashion that the original end-user anatomic data was acquired. In this instance however the data would be reacquired of Jane wearing the dress, which can be directly compared by the QA module 111 with the virtual 3D holographic images which were recently created. The comparison of data from these “real life” and “virtual” 3D images provides important objective feedback data for refinement of the 3D holographic technology. This type of objective feedback data may be incorporated into the “return policy” of the vendor so as to provide both subjective and objective data for all products returned following use of the 3D holographic technology.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A virtual imagery and multi-sensory system, comprising:
a plurality of biological sensors and environmental sensors, which receive input from one or more users and an environment of said one or more users, respectively, which input is provided to a three-dimensional (3D) visualization module;
a plurality of image-capturing devices which take and forward images to said 3D visualization module which creates 3D virtual imagery of said one or more users; and
a projection system which projects said 3D virtual imagery of said one or more users integrated by said 3D visualization module with said input from said plurality of biological sensors and environmental sensors, such that said one or more users experience sensory interactions with said 3D virtual imagery using said plurality of biological and environmental sensors.

2. The virtual imagery and multi-sensory system of claim 1, wherein said plurality of image-capturing devices include at least one of cameras, radiographic devices, ultrasound, or volumetric medical imaging.

3. The virtual imagery and multi-sensory system of claim 1, wherein said biological sensors include at least one of visual, auditory, taste, tactile, or olfactory sensors, and said environmental sensors include at least one of pressure, acoustic, temperature, or air quality sensors.

4. The virtual imagery and multi-sensory system of claim 1, further comprising:
a plurality of external systems which are configured to change said environment of said one or more users;
wherein said plurality of external systems change said environment based upon changes requested by said one or more users.

5. The virtual imagery and multi-sensory system of claim 1, wherein said plurality of external systems includes at least one of an HVAC system or a drug/gas toxicity system.

6. The virtual imagery and multi-sensory system of claim 4, wherein said 3D virtual imagery is a hologram.

7. The virtual imagery and multi-sensory system of claim 6, wherein when said hologram provides one or more users sensory interactions using at least one of said plurality of biological sensors, said plurality of environmental sensors, or said plurality of external systems, feedback from said one or more users from interaction with said hologram is returned to said 3D visualization module, such that said 3D visualization module can continuously modify output to said hologram, and said plurality of biological sensors, said plurality of environmental sensors, and said plurality of external systems, to accommodate for any biological, environmental or temporal changes.

8. The virtual imagery and multi-sensory system of claim 7, wherein said one or more users can request customization of said hologram.

9. The virtual imagery and multi-sensory system of claim 7, wherein computerized simulation is integrated into an environment to provide real-life analysis of a catastrophic environmental event.

10. The virtual imagery and multi-sensory system of claim 7, wherein said modified output to said hologram shows changes in anatomy which occurred over a defined period of time of said one or more users.

11. The virtual imagery and multi-sensory system of claim 10, wherein said 3D visualization module compares and correlate real-life data and virtual data from said hologram, said one or more users, and said environment, to accomplish iterative technology refinement.

12. The virtual imagery and multi-sensory system of claim 11, wherein multiple holographic images are simultaneously utilized for analysis by said 3D visualization module, which may be related to different entities or objects or intrinsic to a same entity or object.

13. The virtual imagery and multi-sensory system of claim 7, further comprising:
a quality assurance module which analyzes hologram image quality from said feedback from said one or more users;
wherein when said hologram image quality varies from prior data measurements, then quality assurance testing is required to determine any discrepancies.

14. The virtual imagery and multi-sensory system of claim 7, wherein virtual testing is performed using said hologram, where variables to said hologram are adjusted to provide dynamic feedback to said one or more users in accordance with their individual concerns.

15. The virtual imagery and multi-sensory system of claim 14, wherein said feedback based on said hologram can be analyzed for trending analysis among large populations of end-users.

16. The virtual imagery and multi-sensory system of claim 7, wherein said hologram is used in medical applications.

17. The virtual imagery and multi-sensory system of claim 16, wherein said medical application includes one of a virtual surgery, or a virtual surgical tool.
